(19) United States
(12) Patent Application Publication
(10) Pub. No.: US 2012/0011092 A1
(43) Pub. Date: Jan. 12, 2012

(54) METHODS AND SYSTEMS FOR MEMRISTOR-BASED NEURON CIRCUITS

(75) Inventors: Yi Tang, San Diego, CA (US); Venkat Rangan, San Diego, CA (US); Jeffrey A. Levin, San Diego, CA (US); Subramaniam Venkatraman, San Diego, CA (US)

(73) Assignee: QUALCOMM INCORPORATED, San Diego, CA (US)

(21) Appl. No.: 12/831,831

(22) Filed: Jul. 7, 2010

(51) Int. Cl. G06N 3/04

(52) U.S. Cl. 706/33

(57) ABSTRACT

Certain embodiments of the present disclosure support techniques for designing neuron circuits based on memristors. Bulky capacitors as electrical current integrators can be eliminated and nanometer scale memristors can be utilized instead. Using the nanometer feature-sized memristors, the neuron hardware area can be substantially reduced.

### FIELD

Certain embodiments of the present disclosure generally relate to neural system engineering and, more particularly, to designing neuron circuits based on memristors.

### BACKGROUND

Neural system engineering has been attracting significant attention in recent years. Inspired by a biological brain with excellent flexibility and power efficiency, neural systems can be employed in many applications such as pattern recognition, machine learning and motor control. One of the biggest challenges of a practical neural system implementation is hardware density. Neurons and synapses are the two fundamental components of a neural system whose quantity can be as high as billions. As an example, a human brain has approximately 10¹¹ neurons.

As a result, in order to implement practical neural systems, the neuron hardware is required to be extremely area efficient. In existing analog neuron implementations, area efficiency is limited by an integrating capacitor that mimics the neuron membrane capacitance. In order to design neurons operating with a time constant close to that of biological systems (e.g., approximately 1 ms), hundreds of femto-Farad (fF) capacitance (where 1 fF equals 10̂-15 Farad) is required even with minimal integrating current. Therefore, an area consumed by a single neuron can be quite large, especially with low-density on-chip capacitors (e.g., with densities of 2 to 11 fF/μm²).

### SUMMARY

Certain embodiments of the present disclosure provide a neuron electrical circuit. The electrical circuit generally includes a memristor configured to integrate current, in response to an input signal, to cause a change in membrane voltage potential, and a firing circuit configured to generate an output pulse when the membrane voltage potential reaches a threshold level, the output pulse indicating firing of the neural electrical circuit.

Certain embodiments of the present disclosure provide a method for implementing a neuron electrical circuit. The method generally includes integrating current with a memristor in the neuron electrical circuit to cause a change in membrane voltage potential, and generating an output pulse when the membrane voltage potential reaches a threshold level, the output pulse indicating firing of the neuron electrical circuit.

Certain embodiments of the present disclosure provide an apparatus for implementing a neuron electrical circuit. The apparatus generally includes means for integrating current with a memristor in the neuron electrical circuit to cause a change in membrane voltage potential, and means for generating an output pulse when the membrane voltage potential reaches a threshold level, the output pulse indicating firing of the neuron electrical circuit.

Certain embodiments of the present disclosure provide an electrical circuit. The electrical circuit generally includes a memristor configured to integrate an input electrical current, wherein a voltage potential across the memristor changes as the electrical current flows through the memristor, and a firing circuit configured to generate an output pulse when the voltage potential reaches a threshold level, the output pulse indicating firing of the electrical circuit.

Certain embodiments of the present disclosure provide a method for implementing an electrical circuit. The method generally includes integrating an electrical current with a memristor in the electrical circuit, wherein a voltage potential across the memristor changes as the electrical current flows through the memristor, and generating an output pulse when the voltage potential reaches a threshold level, the output pulse indicating firing of the electrical circuit.

Certain embodiments of the present disclosure provide an apparatus for implementing a neuron electrical circuit. The apparatus generally includes means for integrating an electrical current with a memristor in the electrical circuit, wherein a voltage potential across the memristor changes as the electrical current flows through the memristor, and means for generating an output pulse when the voltage potential reaches a threshold level, the output pulse indicating firing of the electrical circuit.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example neural system in accordance with certain embodiments of the present disclosure.

FIG. 2 illustrates an example memristor structure in accordance with certain embodiments of the present disclosure.

FIG. 3 illustrates an example current-voltage characteristic of a memristor in accordance with certain embodiments of the present disclosure.

FIG. 4 illustrates an example block diagram of a memristor-based integrator in accordance with certain embodiments of the present disclosure.

FIG. 5 illustrates an example timing diagram of the memristor-based integrator in accordance with certain embodiments of the present disclosure.

FIG. 6 illustrates an example schematic of the memristor-based integrator in accordance with certain embodiments of the present disclosure.

FIG. 7 illustrates an example waveform of the memristor-based integrator in accordance with certain embodiments of the present disclosure.

FIG. 8 illustrates example operations for implementing the memristor-based integrator in accordance with certain embodiments of the present disclosure.

FIG. 8A illustrates example components capable of performing the operations illustrated in FIG. 8.

FIG. 9 illustrates an example neuron circuit in accordance with certain embodiments of the present disclosure.

FIG. 10 illustrates an example timing diagram of the neuron circuit of FIG. 9 in accordance with certain embodiments of the present disclosure.

FIG. 11 illustrates an example memristor as a current-in resistance-out integrator in accordance with certain embodiments of the present disclosure.

FIG. 12 illustrates an example transient response comparison of a memristor resistance supplied with two electrical currents of different frequencies in accordance with certain embodiments of the present disclosure.

FIG. 13 illustrates an example response of a memristor resistance amplitude for a sinusoidal input current in accordance with certain embodiments of the present disclosure.

FIG. 14 illustrates an example memristor element serially connected with a regular resistor for measuring integral of an input current in accordance with certain embodiments of the present disclosure.

FIG. 15 illustrates example operations for implementing a current-in resistance-out integrator based on a memristor element in accordance with certain embodiments of the present disclosure.

FIG. 15A illustrates example components capable of performing the operations illustrated in FIG. 15.

FIG. 16 illustrates an example small signal implementation of a memristor element for filtering in accordance with certain embodiments of the present disclosure.

FIG. 17 illustrates example operations for implementing a low-pass filter based on a memristor element in accordance with certain embodiments of the present disclosure.

FIG. 17A illustrates example components capable of performing the operations illustrated in FIG. 17.

### DETAILED DESCRIPTION

Various embodiments of the disclosure are described more fully hereinafter with reference to the accompanying drawings. This disclosure may, however, be embodied in many different forms and should not be construed as limited to any specific structure or function presented throughout this disclosure. Rather, these embodiments are provided so that this disclosure will be thorough and complete, and will fully convey the scope of the disclosure to those skilled in the art. Based on the teachings herein one skilled in the art should appreciate that the scope of the disclosure is intended to cover any embodiment of the disclosure disclosed herein, whether implemented independently of or combined with any other embodiment of the disclosure. For example, an apparatus may be implemented or a method may be practiced using any number of the embodiments set forth herein. In addition, the scope of the disclosure is intended to cover such an apparatus or method which is practiced using other structure, functionality, or structure and functionality in addition to or other than the various embodiments of the disclosure set forth herein. It should be understood that any embodiment of the disclosure disclosed herein may be embodied by one or more elements of a claim.

The word “exemplary” is used herein to mean “serving as an example, instance, or illustration.” Any embodiment described herein as “exemplary” is not necessarily to be construed as preferred or advantageous over other embodiments.

Although particular embodiments are described herein, many variations and permutations of these embodiments fall within the scope of the disclosure. Although some benefits and advantages of the preferred embodiments are mentioned, the scope of the disclosure is not intended to be limited to particular benefits, uses or objectives. Rather, embodiments of the disclosure are intended to be broadly applicable to different technologies, system configurations, networks and protocols, some of which are illustrated by way of example in the figures and in the following description of the preferred embodiments. The detailed description and drawings are merely illustrative of the disclosure rather than limiting, the scope of the disclosure being defined by the appended claims and equivalents thereof.

### Exemplary Neural System

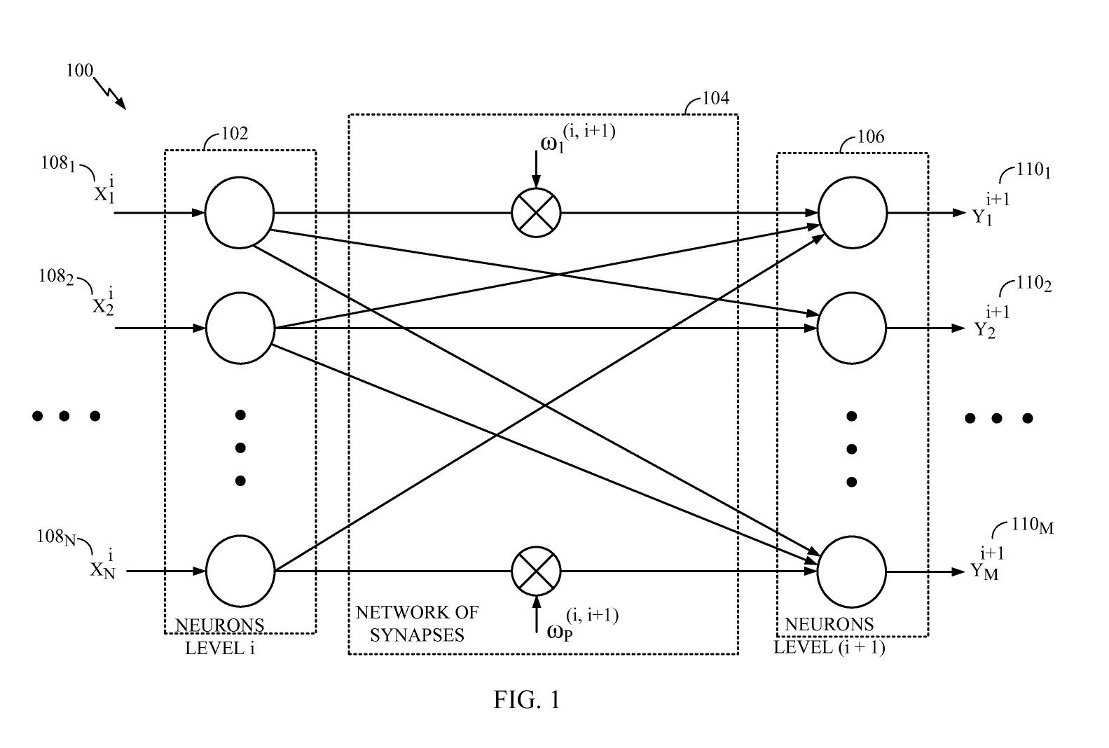

FIG. 1 illustrates an example neural system 100 with multiple levels of neurons in accordance with certain embodiments of the present disclosure. The neural system 100 may comprise a level of neurons 102 connected to another level of neurons 106 though a network of synapse connections 104. For simplicity, only two levels of neurons are illustrated in FIG. 1, although many more levels of neurons may exist in a typical neural system.

As illustrated in FIG. 1, each neuron in the level 102 may receive an input signal 108 that may be generated by a plurality of neurons of a previous level (not shown in FIG. 1). The signal 108 may represent an input current of one of the level 102 neurons. This current may be accumulated on the neuron “membrane” to charge a “membrane potential.” When the membrane potential reaches a threshold value, the neuron may fire and output a spike to be transferred to the next level of neurons (e.g., the level 106).

The transfer of spikes from one level of neurons to another may be achieved through the network of synaptic connections (or simply “synapses”) 104, as illustrated in FIG. 1. The synapses 104 may receive output signals (i.e., spikes) from the level 102 neurons, scale those signals according to adjustable synaptic weights w₁^{(i,i+1)}, . . . , w_{P}^{(i,i+1)} (where P is a total number of synaptic connections between the neurons of levels 102 and 106), and combine the scaled signals as an input signal of each neuron in the level 106. Every neuron in the level 106 may generate output spikes 110 based on the corresponding combined input signal. The output spikes 110 may be then transferred to another level of neurons using another network of synaptic connections (not shown in FIG. 1).

The neural system 100 may be emulated by an electrical circuit and utilized in a large range of applications, such as pattern recognition, machine learning and motor control. Each neuron in the neural system 100 may be implemented as a neuron circuit. The neuron membrane charged to the threshold value initiating the output spike may be implemented as a capacitor which integrates an electrical current that flows through it.

Certain embodiments of the present disclosure may eliminate the capacitor as the electrical current integrating device and use a memristor element in its place. With nanometer feature-sized memristors, the area of neuron circuit may be substantially reduced, which may make implementation of a very large-scale neural system hardware implementation practical. This approach may be applied in neuron circuits, as well as in various other applications where bulky capacitors are utilized as electrical current integrators.

For example, most analog filters may require the use of capacitive elements to perform integrating functions. These capacitors may be large and may limit the number of filters practically implementable on a single chip. Replacing a capacitor with a small memristor device that performs the same integrating function may allow scaling up the number of filters on the chip by a large number. In addition, the analog filters based on memristors may represent very compact-sized circuits with low power dissipation. The applications of such solutions may be also extended to the radio frequency (RF) domain.

### Exemplary Memristor Element

The memristor is sometimes referred to as the fourth elementary passive element. Its small feature size makes the memristor very attractive for large-scale hardware implementations. Possible future applications of memristors can include, among others, ultra-dense memory cells and neural computing.

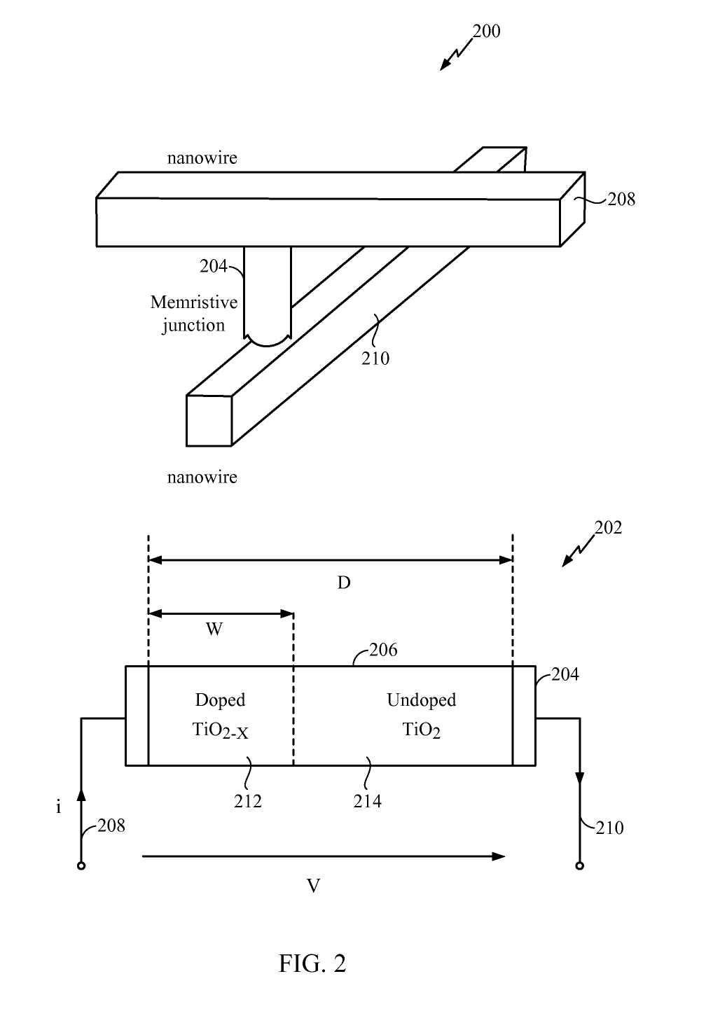

FIG. 2 illustrates a structure 200 and a model 202 of an example memristor element 204. The memristor 204 may comprise a two-layer thin film 206 of TiO₂, which may be sandwiched between two nano-wires 208-210 that serve as contacts. One layer (i.e., a layer 212) may be doped with oxygen vacancies and behave like semiconductor, while another un-doped layer 214 may function as an insulator. The overall memristor resistance Rₘₑₘ may depend on the boundary position of the two layers as:

$${R}_{mem} = {R}_{on} \frac{W ( t )}{D} + {R}_{off} \frac{D - W ( t )}{D} , \qquad ( 1 )$$

where W is a width of the doped layer 212, D is a total length of the TiO₂ layer 206, Rₒₙ and R_{off} represent limit values of the memristor resistance for W=0 and W=D, respectively.

As an electrical current i passes through the memristor 204 over time, the current may modulate the memristor resistance by changing the doped layer width W as:

$$\frac{d W}{d t} = μ \frac{{R}_{on}}{D} i ( t ) , \qquad ( 2 )$$

where μ represents a memristor dopant mobility. Once the current i flows into the memristor 204 in one direction (i.e., from the wire 210 to the wire 208), it may reduce the width W of the doped layer 212 to zero and may saturate the memristor resistance to the largest possible value R_{off}. When direction of the current i is reverse (i.e., from the wire 208 to the wire 210), the doped layer 212 may tend to occupy the entire memristor width D, and the minimum memristor resistance of Rₒₙ may be reached.

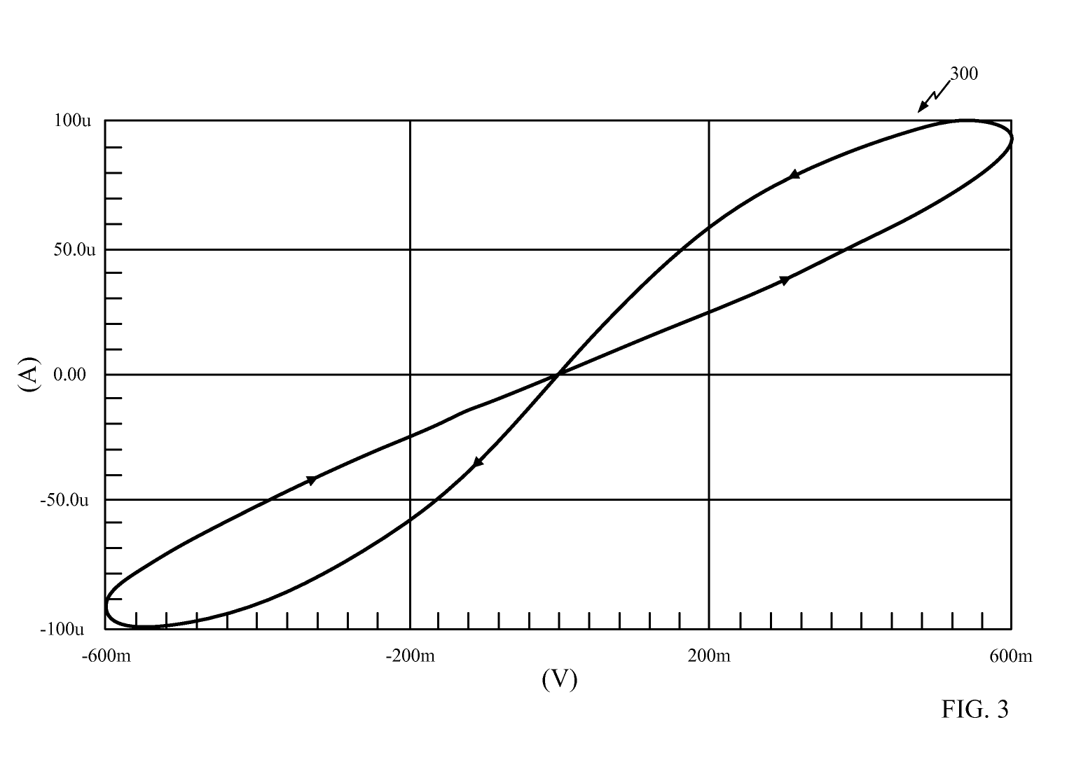

FIG. 3 illustrates an example simulated electrical current-voltage (I-V) characteristic 300 of a memristor element in accordance with certain embodiments of the present disclosure. It can be observed from FIG. 3 that the memristor behavior can be described with the hysteresis I-V curve. There may be no electrical current flowing through the memristor if there is no voltage applied across the memristor, as the hysteresis curve 300 passes through the origin. This implies that the memristor may be a purely dissipative element.

The increase of memristor current may cause the voltage across the memristor also to increase until the minimum memristance Rₒₙ is reached. Then, the decrease of memristor current may cause the memristor voltage also to decrease because the memristance is at the constant and minimum level. When the electrical current of the memristor flows in the opposite direction and increases, then the memristance may increase and the negative voltage across the memristor may increase. When the maximum memristance R_{off} is reached, then the decrease of the memristor current flowing in this opposite direction may cause the negative memristor voltage also to decrease, as illustrated in FIG. 3.

Certain embodiments of the present disclosure utilize a memristor as an integrating device to implement an integrate-and-fire neuron circuit within the neural system 100. The same concept may be applied to implement neurons with various other models. The goal is to eliminate a capacitor as the electrical current integrating device in conventional complementary metal-oxide-semiconductor (CMOS) neuron circuits to save implementation area while maintaining low power operations.

### Exemplary Integrating Memristor Neuron Circuit

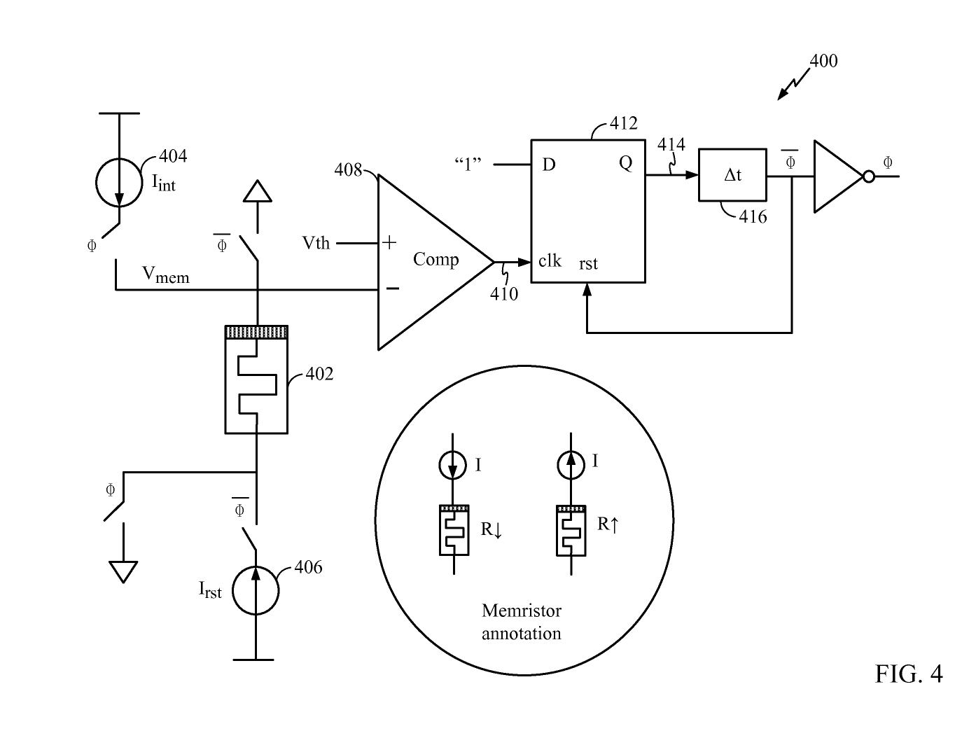

FIG. 4 illustrates an example integrate-and-fire neuron circuit 400 with a memristor element (or simply “memristor”) 402. The memristor 402 may perform a current integrating function with a constant DC current. The memristor 402 may be connected to two different current sources 404 and 406 with opposite directions at an integration phase Φ_{I} and at a reset phase Φ_{R}, respectively.

The electrical current Iᵢₙₜ of the current source 404 may represent an input current to the neuron circuit 400. As described above, this current may be accumulated on a neuron membrane to charge a membrane potential. When the potential reaches a defined threshold voltage, then the neuron circuit 400 may fire and output a spike. The current Iᵣₛₜ of the current source 406 may be utilized to reset the neuron circuit to a desired level after it fires the output spike.

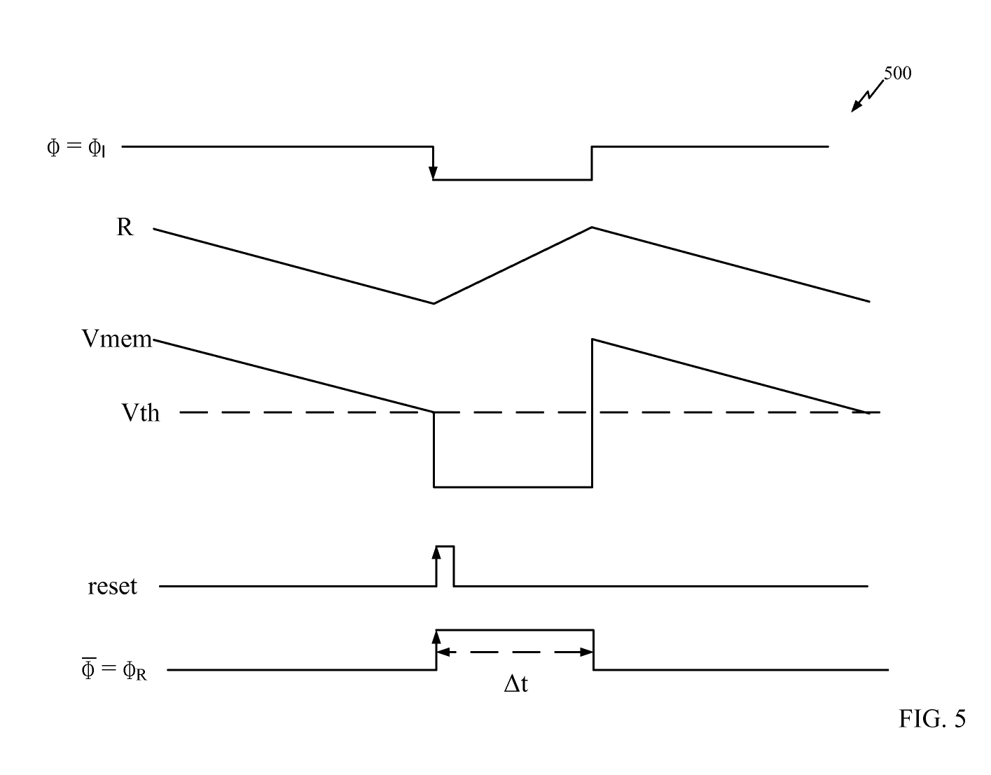

FIG. 5 illustrates timing diagrams associated with the neuron circuit 400 based on the memristor element 402. During the Φ_{I} phase (i.e., when Φ=Φ_{I}=1), the input current Iᵢₙₜ of the current source 404 may flow into the memristor 402 and may reduce its resistance R, as illustrated in FIG. 5. As a result, a voltage Vₘₑₘ across the memristor 402 representing the neuron membrane potential may decrease correspondingly. The neuron circuit 400 may fire when the voltage Vₘₑₘ becomes lower than the threshold voltage Vₜₕ. An output 410 of a comparator 408 may switch from “0” to “1” and trigger a D flip-flop 412 to generate a reset pulse 414 (i.e., the signal “reset” in FIG. 5).

During the reset phase Φ_{R} (i.e., when Φ̅=Φ_{R}=1), the constant current Iᵣₛₜ of the current source 406 may flow out of the memristor 402 to increase the memristor resistance. The pulse width Δt of the reset phase Φ_{R} illustrated in FIG. 5 (i.e., the width of the output spike) may be determined by a delay element 416 and should be chosen properly along with the reset current Iᵣₛₜ to reset the memristor resistance to a desired value after the neuron circuit fires. After the reset phase, the neuron circuit 400 may return to the integration phase (i.e., when Φ=Φ_{I}=1) and resume integrating the input current 404.

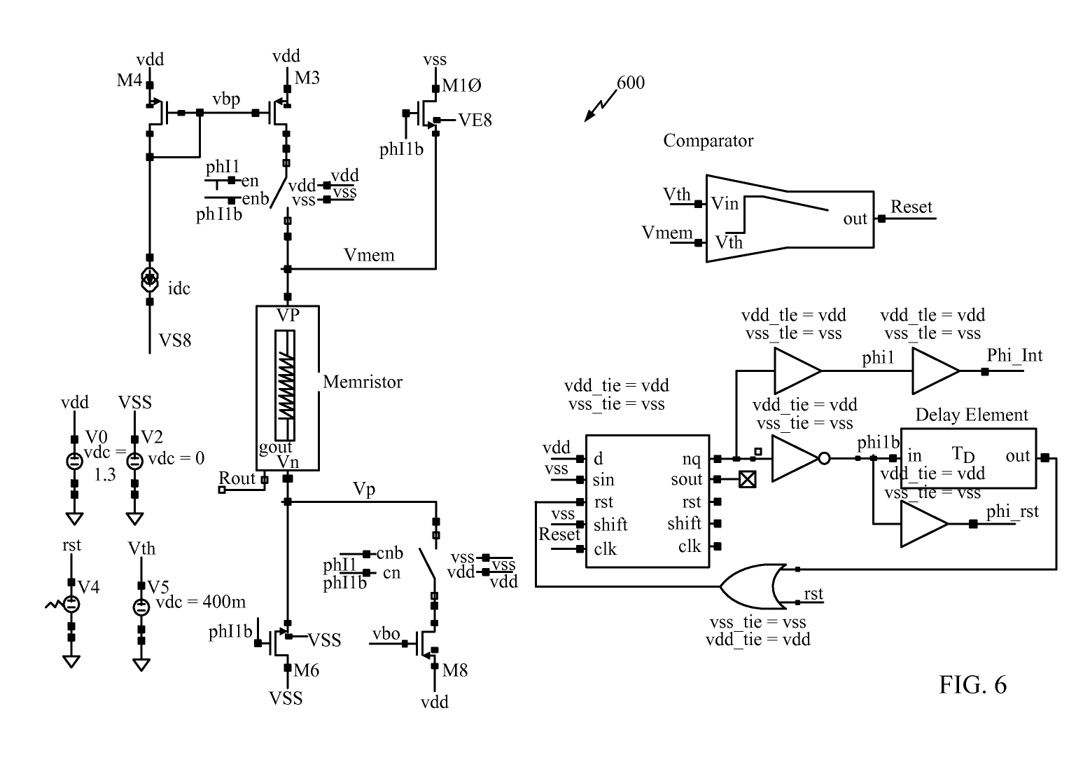

FIG. 6 illustrates an example model 600 that may be used to verify operation of the neuron circuit 400. To minimize the power consumption, the memristor 402 may initially reset to its R_{off} value of, for example, 30 MΩ. During the integrating phase, the DC current 404 of 20 nA may be input into the memristor 402. The memristor resistance and the voltage Vₘₑₘ across the memristor 402 may be gradually reduced as the electrical current 404 integrates over time.

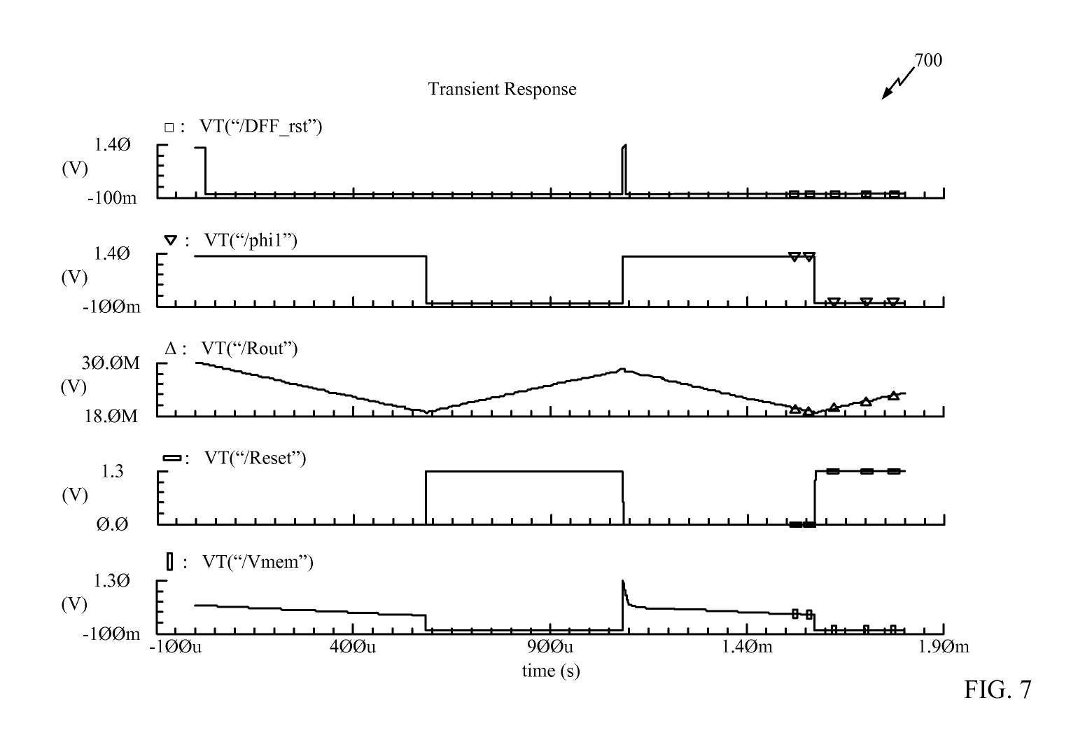

FIG. 7 illustrates an example simulation waveforms of the model 600 in accordance with certain embodiments of the present disclosure. Once the voltage Vₘₑₘ becomes lower than the defined threshold voltage Vₜₕ of the memristor (e.g., 400 mV in this particular simulation, which corresponds to 0.2V neuron membrane voltage drop), the neuron may fire a spike labeled as the “Reset” signal in FIG. 7.

To achieve a time constant in the order of milliseconds while maintaining a nano-amper current consumption, the memristor may need quickly to transfer its charge. To achieve this, the memristor dopant mobility Uv defined in equation (1) can be chosen, for example, to be 3·10⁻⁸. This value represents implementable dopant mobility since memristors used nowadays for non-volatile memories are required to read/write at a faster rate.

For comparison purpose, a capacitor can be considered as the integrating element of the neuron circuit 400 replacing the memristor element 402. If the membrane voltage of, for example, 0.2V is required for the neuron circuit 400 to spike (i.e., the same voltage as for the memristor based neuron), then the capacitor may need to be charged up or down by 0.2V with 20 nA current within 0.5 ms. Then, the following may hold:

$$I = C \frac{d V}{d T} = C \frac{0.2}{0.5 \cdot {10}^{- 3}} = 20 \cdot {10}^{- 9} . \qquad ( 3 )$$

It leads from equation (3) that the capacitance C of 50 pF may be required, which may consume approximately 5000 μm² silicon area. On the other hand, utilizing the nanometer scale memristor instead of the bulky capacitor, most of this 5000 μm² area may be saved. Therefore, the memristor-based neurons represent much denser solution for the neuron implementation than capacitor-based neuron circuits.

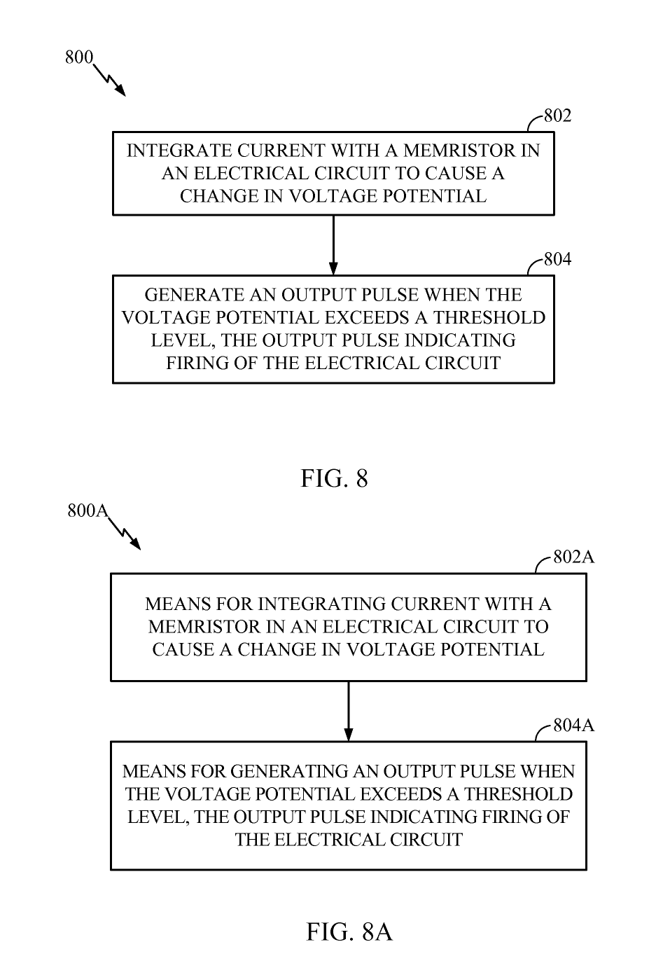

FIG. 8 illustrates example operations 800 for implementing an integrating electrical circuit based on a memristor in accordance with certain embodiments of the present disclosure. This memristor-based integrator may be also an integrate-and-fire neuron circuit. At 802, an electrical current may be integrated with a memristor in the electrical circuit to cause a change in voltage potential (e.g., a membrane voltage potential of the neuron electrical circuit). At 804, an output pulse may be generated when the voltage potential reaches a threshold level, the output pulse may indicate firing of the electrical circuit.

### Exemplary Memristor-Based Neuron

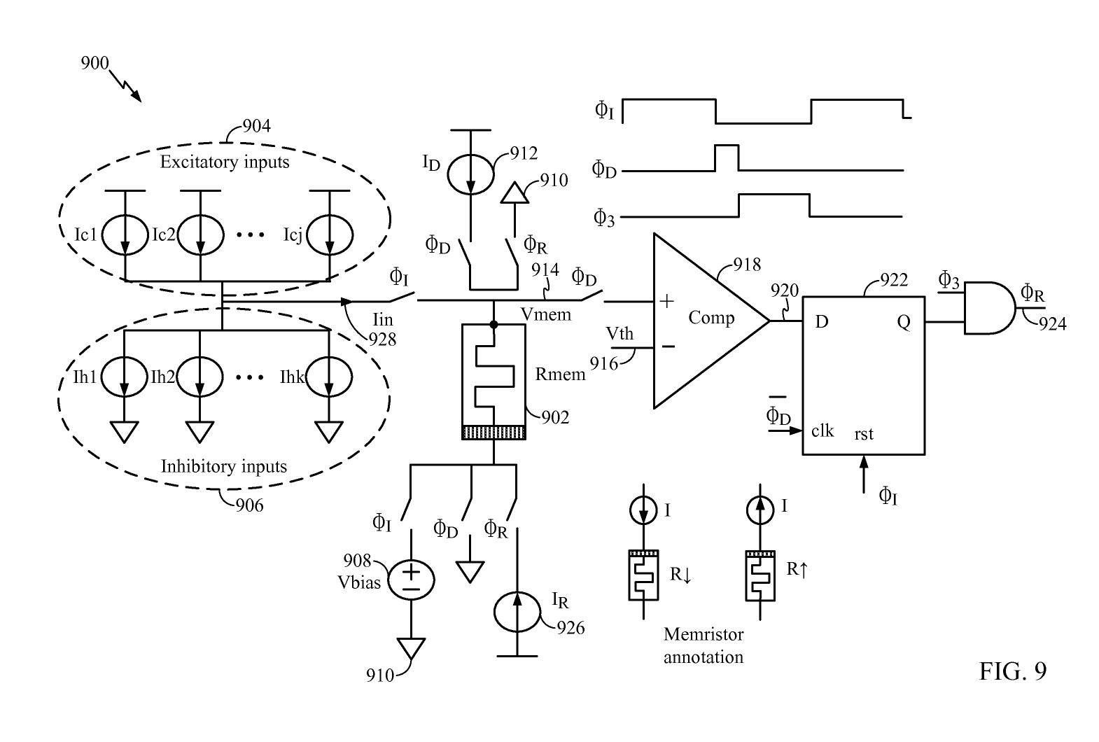

As discussed above, a nano-scale memristor may replace the bulky capacitor to perform the integration function with a constant DC current. However, an electrical current flowing into a neuron may vary substantially, for example, it may be excitatory or inhibitory. FIG. 9 illustrates an example neuron circuit 900 with arbitrary current inputs with a single memristor element 902 in accordance with certain embodiments of the present disclosure. The memristor 902 may be switched with a three-phase clock, as illustrated in FIG. 9 with clock phases Φ_{I}, Φ_{D}, and Φ₃.

During the integration phase Φ₁, all input currents of the neuron circuit 900 including both the excitatory inputs 904 and inhibitory inputs 906 may be passing through the memristor 902 in such a way that the excitatory input currents 904 may increase the memristor resistance while the inhibitory inputs may decrease the memristance value. For the neuron 900 to be able to source and sink electrical currents, one terminal of the memristor 902 may be biased at a voltage level defined by a voltage source 908, as illustrated in FIG. 9. The voltage level of the source 908 may be, for example, a half of a power supply 910.

At the end of the Φ_{I} phase, the memristor resistance may be a function of the input currents 904 and 906 integrating over duration φ₁ of the Φ_{I} pulse, i.e.:

$${R}_{mem} ∝ {\int }_{0}^{ϕ I} ( {\sum }_{i = 1}^{j} {Ic}_{i} - {\sum }_{i = 1}^{k} {Ih}_{i} ) d t , \qquad ( 4 )$$

where Icᵢ(i=1, . . . , j) are excitatory input currents 904 and Ihᵢ(i=1, . . . , k) represents inhibitory input currents 906.

The memristor resistance defined by equation (4) may be measured by inputting a constant current source 912 to the memristor 902 during the following detection phase (i.e., when Φ_{D}=1). To minimize the disturbance on the memristor resistance during the measurement, a very small current I_{D} of the current source 912 may be used along with a minimum pulse width of Φ_{D}. Then, a voltage 914 across the memristor 902 may be given by:

$${V}_{mem} = {I}_{D} \cdot {R}_{mem} ∝ {I}_{D} \cdot {\int }_{0}^{ϕ I} ( {\sum }_{i = 1}^{j} {Ic}_{i} - {\sum }_{i = 1}^{k} {Ih}_{i} ) d t . \qquad ( 5 )$$

The detection current I_{D} may be set to a proper magnitude value to model the leakage current of neuron soma.

The voltage 914 may represent the neuron membrane voltage and may be compared with a threshold voltage 916 during the detection phase (i.e., during the period when Φ_{D}=1). If the voltage 914 is higher than the threshold voltage 916, then the neuron 900 may spike and a comparator 918 may generate a logical one at an output 920. The signal 920 may be latched into a D flip-flop 922 at a falling edge of Φ_{D}, and then it may be logically ANDed with a clock signal Φ₃ to generate an output spike 924, as illustrated in FIG. 9.

Therefore, if the neuron 900 spikes, then a reset phase Φ_{R} may be generated and a large reset current 926 may pass through the memristor 902 to quickly decrease the resistance value to a minimum of Rₒₙ. Otherwise, the signal 924 may stay low and the memristor 902 may remain open during the Φ₃ phase. Even though the separate phases may be used for detection and reset, these two phases may be also combined.

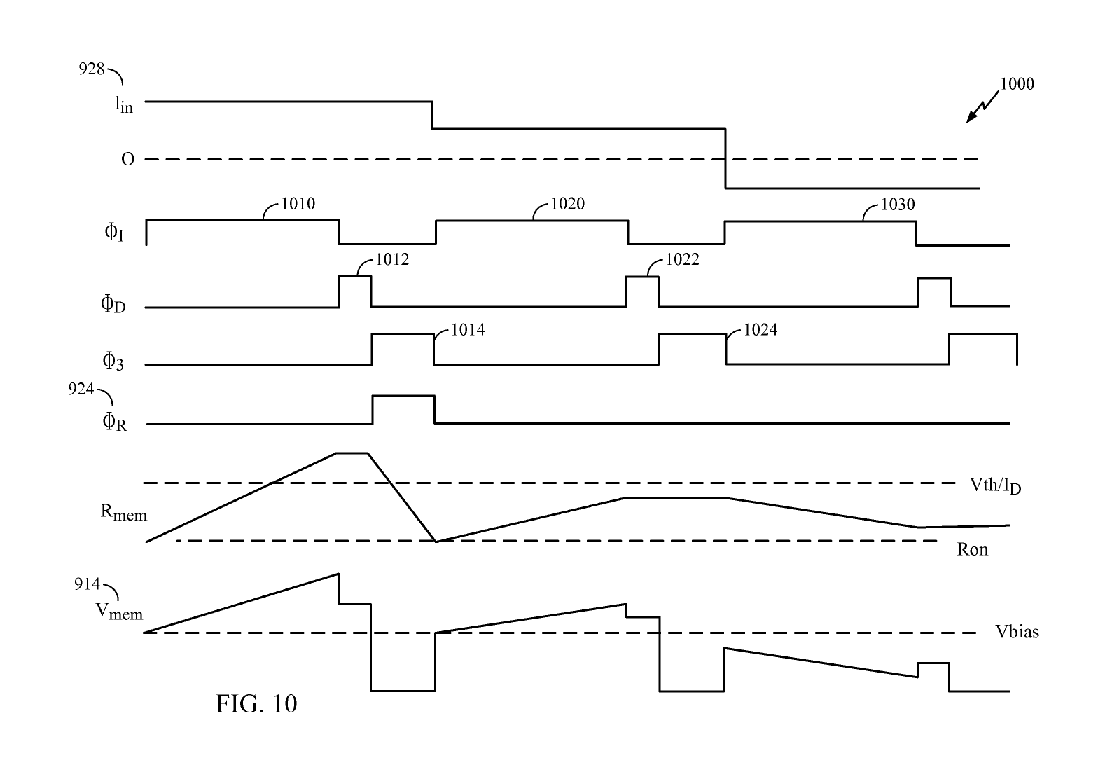

FIG. 10 illustrates an example timing diagram 1000 of the memristor-based integrate-and-fire neuron circuit 900 in accordance with certain embodiments of the present disclosure. During a first Φ_{I} phase 1010, a large positive input current Iᵢₙ corresponding to a current 928 from FIG. 9 may flow into the memristor 902 and may increase its resistance beyond Vₜₕ/I_{D}, where Vₜₕ is the memristor threshold voltage 916.

During the Φ_{D} phase 1012, with the memristor input current of I_{D}, the membrane voltage 914 may be higher the threshold voltage Vₜₕ, and the neuron 900 may spike. The memristor resistance Rₘₑₘ may be then reduced to Rₒₙ with the large reset current 926 flowing through the memristor 902 during the Φ₃ phase 1014, as illustrated in FIG. 10.

During the second integration phase 1020, the memristor resistance may only slightly increase with a small positive input current 928. Since the membrane voltage 914 may be lower than the threshold voltage 916 during the detection phase 1022, no spike may be generated during this phase (i.e., the signal 924 may stay low). Also, there may be no need to reset the memristor resistance Rₘₑₘ and the memristor 902 may be left to float during the Φ₃ phase 1024 instead to keep the original resistance state.

In the third integration phase 1030, the input current 928 may be negative (i.e., the inhibitory currents 906 may be larger than overall excitatory currents 904). Then, as illustrated in FIG. 10, the memristor resistance Rₘₑₘ and the voltage 914 may decrease. Therefore, neither spike not reset phase may be generated.

To verify the function of the neuron circuit from FIG. 9, the neuron 900 can be designed using verilogA models for the memristor 902 and the comparator 918, while other components within the circuit 900 are based on real transistor level design. The output simulation waveforms confirm functioning of the neuron circuit 900 described by the timing diagrams 1000 in FIG. 10.

Compared to the existing CMOS neuron implementations, the neuron design proposed in the present disclosure utilizes the nano-scale memristor as the integrating device instead of the low-density on-chip capacitor. Hence, the more compact neuron design may be achieved enabling potential massive production of neuron circuits.

### Exemplary Memristor Element Frequency Characteristics

Characteristics of a memristor element can be also investigated in the frequency domain. Certain embodiments of the present disclosure support exploiting the memristor frequency characteristics for both large and small signal filtering and other possible applications such as integrating.

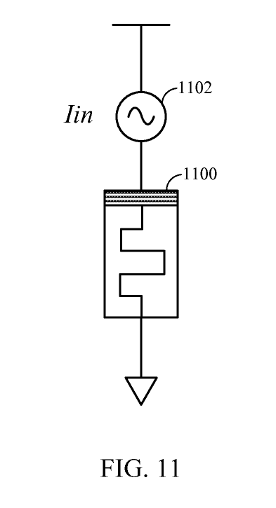

FIG. 11 illustrates an example memristor 1100 as a current-in resistance-out integrator in accordance with certain embodiments of the present disclosure. Considering equation (1), a resistance of the memristor 1100 may be represented in the frequency domain as:

$${R}_{mem} = {R}_{off} + ( {R}_{on} - {R}_{off} ) \frac{W}{D} = {R}_{off} + ( {R}_{on} - {R}_{off} ) \frac{μ}{D} \frac{{R}_{on}}{D} \frac{I}{S} , \qquad ( 6 )$$

where I represents an electrical current of a current source 1102 in frequency domain, and S is the parameter of Laplace integral transform. It can be observed from equation (6) that the memristor 1100 may emulate the current-in resistance-out integrator since the output resistance of the memristor 1100 may be proportional to an integral of the input current, i.e.:

$${R}_{out} = {R}_{mem} ∝ \int {i}_{in} d t = \frac{{I}_{in}}{S} . \qquad ( 7 )$$

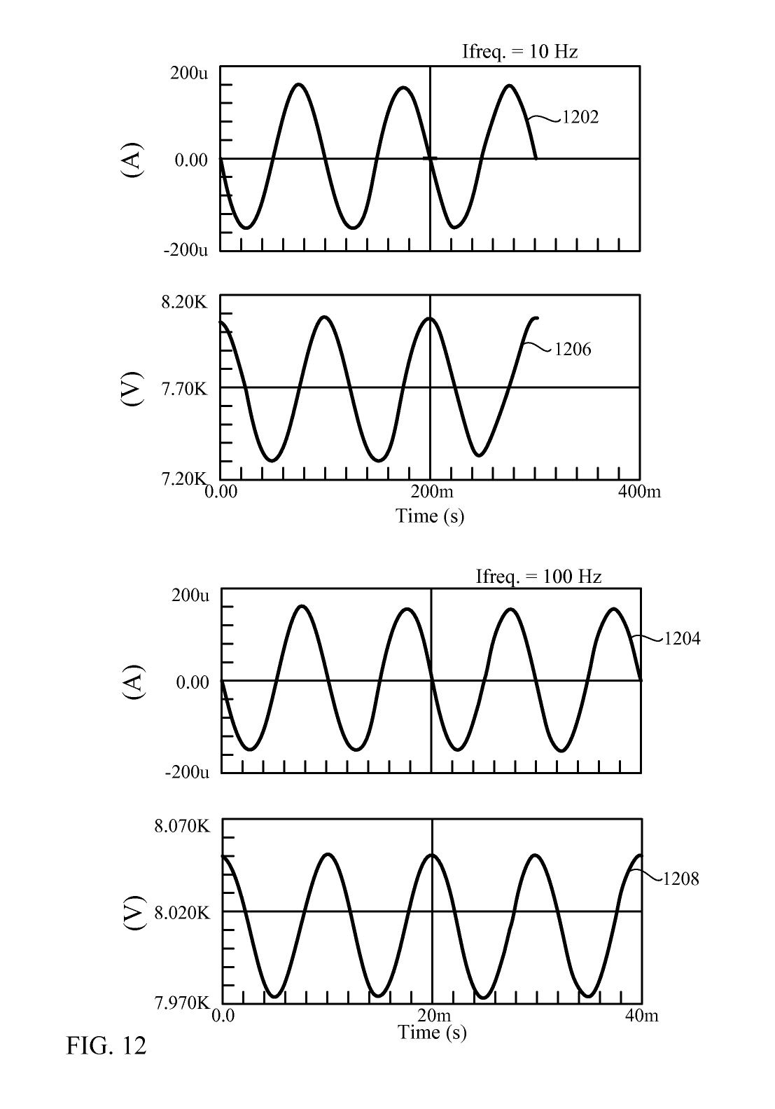

FIG. 12 illustrates an example transient response comparison of a memristor resistance, wherein the memristor may be supplied with two sinusoidal currents 1202 and 1204 of different frequencies in accordance with certain embodiments of the present disclosure. The currents 1202-1204 may have the same amplitude. However, the current 1202 may be of, for example, ten times higher frequency than the current 1204.

As illustrated in FIG. 12, a memristor resistance 1206 may closely follow the input current 1202, while a memristor resistance 1208 may closely follow the input current 1204. Each of the resistances 1206-1208 may increase with a positive current input and may decrease as the corresponding current becomes negative. However, an amplitude of the memristor resistance 1206 may be substantially larger compare to an amplitude of the memristor resistance 1208. Therefore, in general, the memristor resistance amplitude may be larger for the input current of a lower frequency.

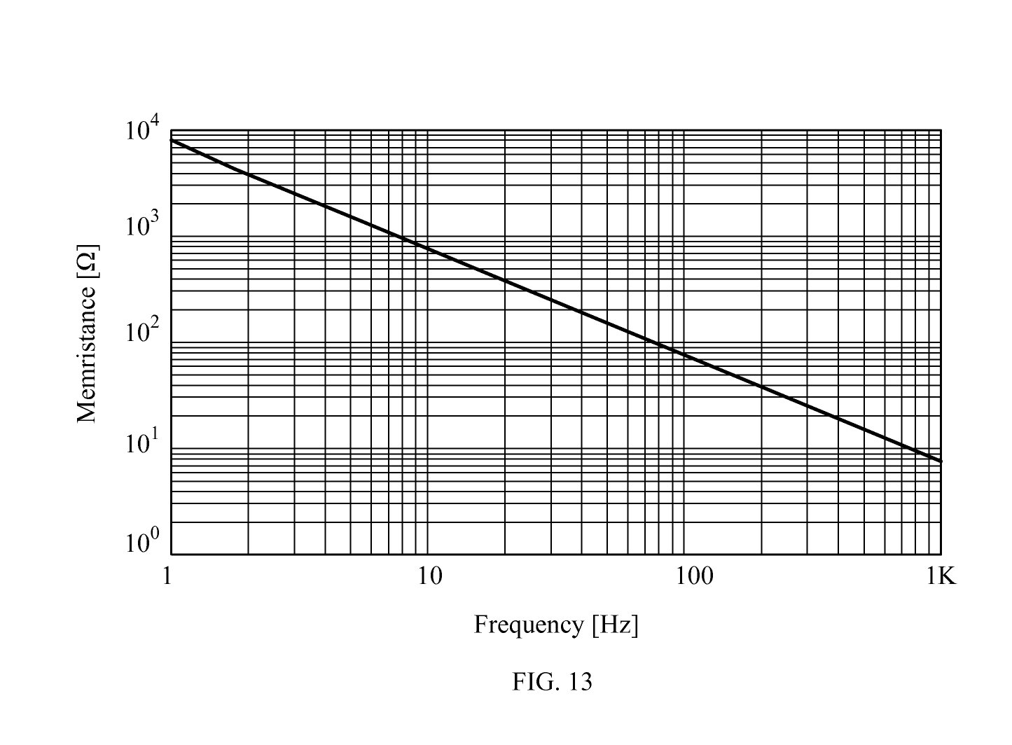

FIG. 13 illustrates an example response 1300 of a memristor resistance amplitude for a sinusoidal input current in accordance with certain embodiments of the present disclosure. The frequency of sinusoidal input current may be changed, for example, from 1 Hz to 1000 Hz, as shown in FIG. 13. It can be observed that the memristor resistance amplitude may decrease with a slope of 20 dB/decade as the frequency of input current increases. The simulation result from FIG. 13 also verifies the memristor's integrator characteristics in the frequency domain, i.e., the memristor resistance in the frequency domain may be proportional to an integral of input current, i.e.:

$${R}_{out} ( f ) ∝ \frac{{I}_{in} ( f )}{S} , \qquad ( 8 )$$

where f is a frequency of the input current Iᵢₙ flowing through the memristor, and the parameter of Laplace integral transform S may be defined as S^{def}=j·2πf, j=\sqrt{−1}.

### Exemplary Electrical Circuits Exploiting Memristor Frequency Characteristics

Because of its frequency characteristics, the memristor element may be utilized for various potential applications, such as integrating and filtering. One design challenge to be addressed is to convert a memristor resistance to measurable variables, such as a voltage or an electrical current.

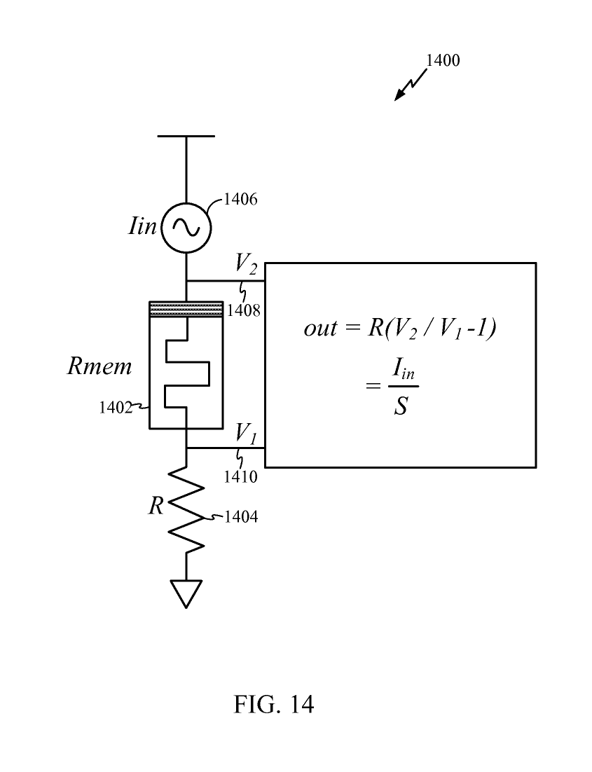

FIG. 14 illustrates an example circuit 1400 of a memristor 1402 serially connected with a regular resistor 1404 for obtaining integral of an input current 1406 in accordance with certain embodiments of the present disclosure. Voltages 1408 and 1410 across the two resistors 1402-1404 may be output and measured in order to calculate a resistance of the memristor 1402. The resistance of the memristor 1402 may be proportional to an integral of the input current 1406:

$${R}_{mem} = \frac{{V}_{2} - {V}_{1}}{{I}_{in}} = \frac{{V}_{2} - {V}_{1}}{{V}_{1} \text{/} R} = R ( {V}_{2} \text{/} {V}_{1} - 1 ) ∝ \frac{{I}_{in}}{S} . \qquad ( 9 )$$

Therefore, according to equation (9), the integral of input current 1402 may be obtained by measuring the voltages 1408-1410. Furthermore, the circuit 1400 may also attenuate high frequency components of the input current 1406 with a 20 dB/decade slope, as illustrated in the graph 1300 of FIG. 13.

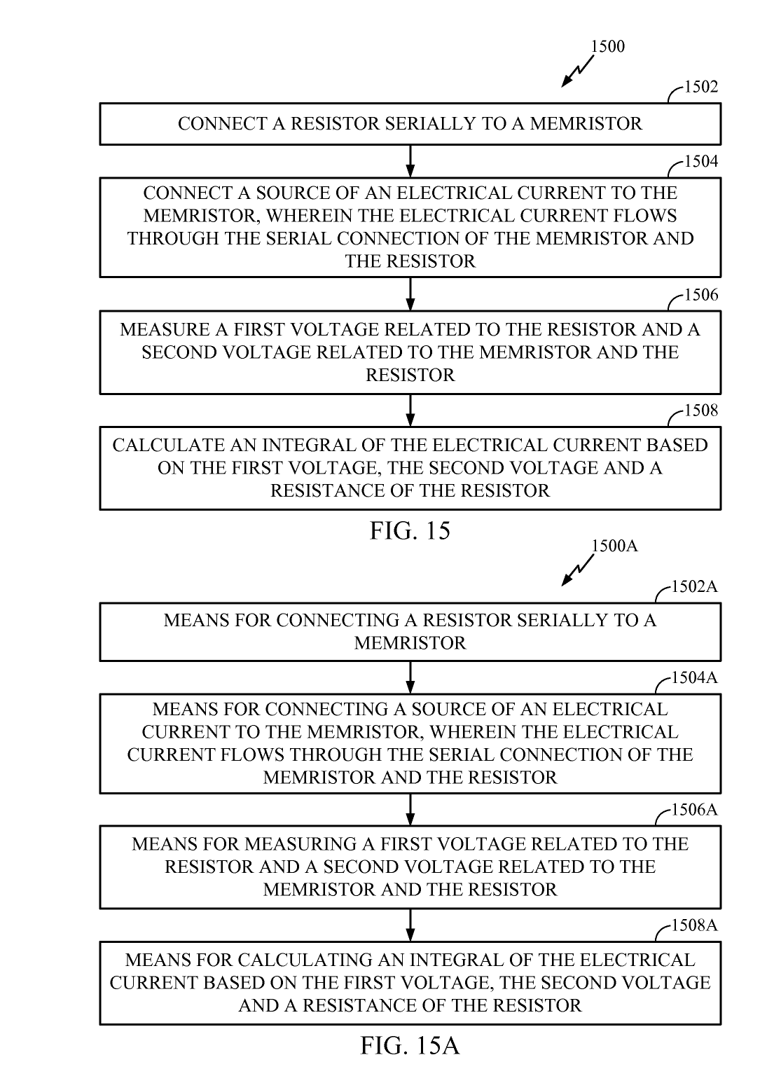

FIG. 15 illustrates example operations 1500 for implementing a current-in resistance-out integrator (e.g., the integrator 1400 from FIG. 14) based on a memristor element in accordance with certain embodiments of the present disclosure. At 1502, a resistor may be serially connected to the memristor. At 1504, a source of an electrical current may be connected to the memristor, wherein the electrical current may flow through the serial connection of the memristor and the resistor. At 1506, a first voltage related to the resistor may be measured, as well as a second voltage related to both the memristor and the resistor. At 1508, an integral of the electrical current may be calculated based on the first voltage, the second voltage and a resistance of the resistor.

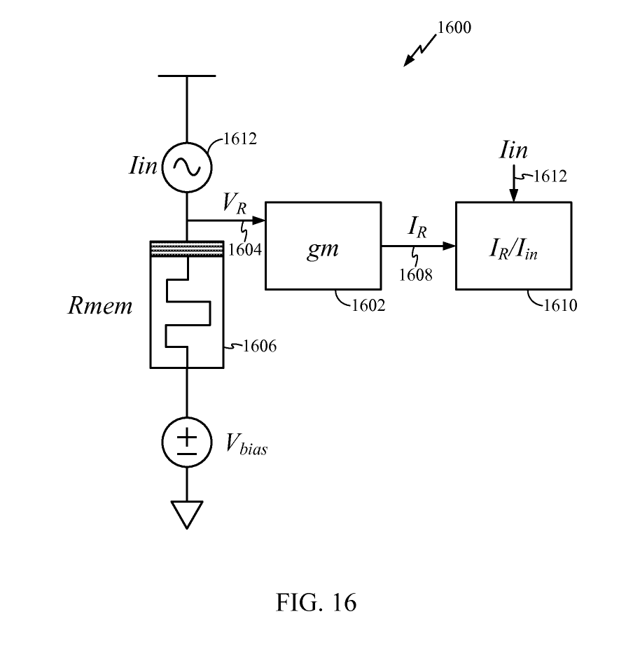

The frequency characteristics of the memristor element may be also exploited along with complementary metal-oxide-semiconductor (CMOS) transistors to implement small signal filtering, as illustrated by a block diagram 1600 in FIG. 16. A trans-conductance block 1602 of a CMOS transistor may convert a voltage 1604 of a memristor 1606 into an electrical current 1608. Then, a current divider block 1610 comprising, for example, a plurality of CMOS transistors may be utilized to calculate a ratio of currents 1608 and 1612 (i.e., a current ratio I_{R}/Iᵢₙ), wherein the current 1612 may be a current flowing through the memristor 1606.

The current ratio I_{R}/Iᵢₙ may be proportional to a resistance Rₘₑₘ of the memristor 1606. Therefore, an output of the current divider 1610 (i.e., the memristance Rₘₑₘ) represents a signal that may be a low-pass filtered version of the electrical current signal 1612. In one embodiment of the present disclosure, the current divider 1610 may be designed by using trans-linear blocks to save power as all the CMOS transistors of the current divider may be operating in a sub-threshold region.

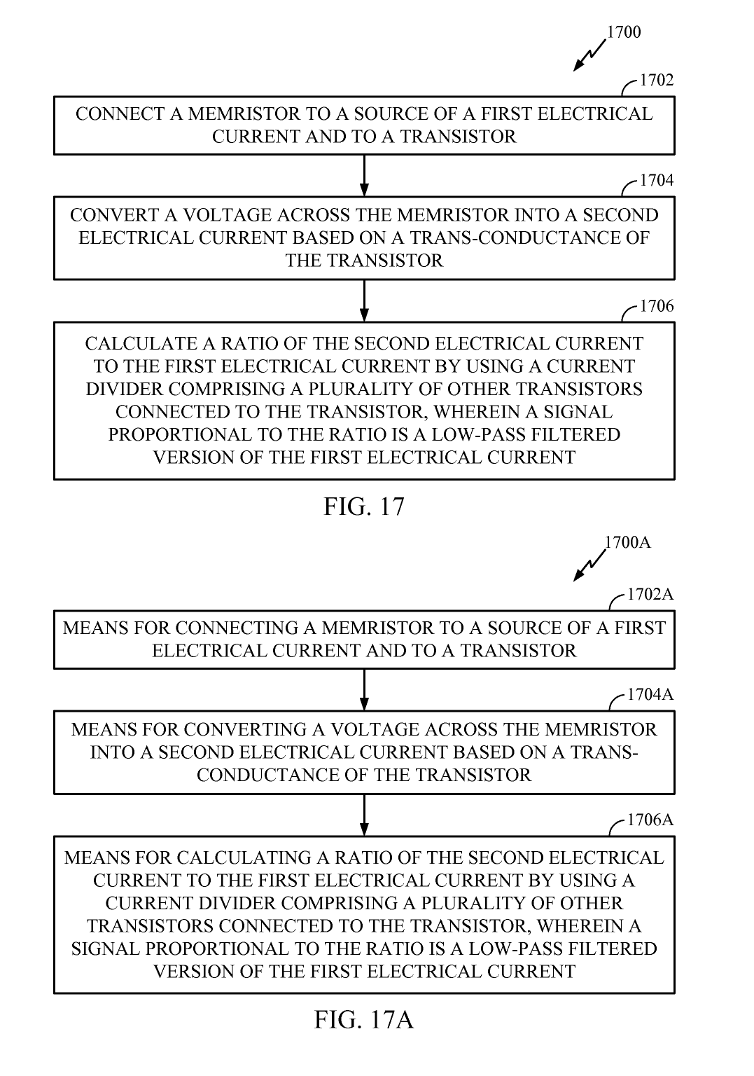

FIG. 17 illustrates example operations 1700 for implementing a low-pass filter (e.g., the filter 1600 from FIG. 16) based on a memristor element and one or more transistors in accordance with certain embodiments of the present disclosure. At 1702, the memristor may be connected to a source of a first electrical current and to a transistor. At 1704, a voltage across the memristor may be converted into a second electrical current based on a trans-conductance of the transistor.

At 1706, a ratio of the second electrical current to the first electrical current may be calculated by using a current divider connected to the transistor comprising a plurality of other transistors. A signal proportional to the ratio may be a low-pass filtered version of the first electrical current. In one embodiment of the present disclosure, the transistor may be a complementary metal-oxide-semiconductor (CMOS) transistor, and the plurality of other transistors may comprise CMOS transistors.

It is shown in the present disclosure that a small area memristor element may be utilized as an electrical current integrating device instead of traditionally used capacitor element. This approach may be applied in a neuron circuit of a neural system where the memristor may emulate the neuron's membrane and integrate its input current. Once the membrane potential reaches a threshold level during the integrating phase, the neuron circuit may fire. With nanometer feature-sized memristors, the area of neuron circuit may be substantially reduced, which may make implementation of a very large-scale neural system hardware implementation practical.

Further, most analog filters traditionally require the use of capacitive elements to perform integrating functions. These capacitors may be large and may limit the number of filters practically implementable on a single chip. Replacing a capacitor with a small memristor device that performs the same integrating function may allow scaling up the number of filters on the chip by a large number. In addition, the analog filters based on memristors may represent very compact-sized circuits with low power dissipation. Applications of such solutions may be also extended to the radio frequency domain.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering. For example, blocks 802-804 illustrated in FIG. 8 correspond to means-plus-function blocks 802A-804A illustrated in FIG. 8A. Similarly, blocks 1502-1508 illustrated in FIG. 15 correspond to means-plus-function blocks 1502A-1504A illustrated in FIG. 15A. Similarly, blocks 1702-1706 illustrated in FIG. 17 correspond to means-plus-function blocks 1702A-1706A illustrated in FIG. 17A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Thus, certain embodiments may comprise a computer program product for performing the operations presented herein. For example, such a computer program product may comprise a computer readable medium having instructions stored (and/or encoded) thereon, the instructions being executable by one or more processors to perform the operations described herein. For certain embodiments, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A neural electrical circuit, comprising:
a memristor configured to integrate current, in response to an input signal, to cause a change in a membrane voltage potential; and
a firing circuit configured to generate an output pulse when the membrane voltage potential reaches a threshold level, the output pulse indicating firing of the neural electrical circuit.

2. The electrical circuit of claim 1, wherein the output pulse is of a defined duration.

3. The electrical circuit of claim 2, wherein the defined duration is chosen such that a resistance of the memristor changes to a defined value during the output pulse.

4. The electrical circuit of claim 2, wherein a resistance of the memristor increases only during the output pulse.

5. The electrical circuit of claim 2, wherein a resistance of the memristor decreases if the membrane voltage potential is larger than the threshold level.

6. The electrical circuit of claim 1, wherein:
a first constant electrical current flows through the memristor in a first direction, before the membrane voltage potential reaches the threshold level during the change; and
a second constant electrical current flows through the memristor in a second direction opposite to the first direction during the output pulse.

7. A method for implementing a neuron electrical circuit, comprising:
integrating current with a memristor in the neuron electrical circuit to cause a change in a membrane voltage potential; and
generating an output pulse when the membrane voltage potential reaches a threshold level, the output pulse indicating firing of the neuron electrical circuit.

8. The method of claim 7, wherein the output pulse is of a defined duration.

9. The method of claim 8, wherein the defined duration is chosen such that a resistance of the memristor changes to a defined value during the output pulse.

10. The method of claim 8, wherein a resistance of the memristor increases only during the output pulse.

11. The method of claim 8, wherein a resistance of the memristor decreases if the membrane voltage potential is larger than the threshold level.

12. The method of claim 7, wherein:
a first constant electrical current flows through the memristor in a first direction, before the membrane voltage potential reaches the threshold level during the change; and
a second constant electrical current flows through the memristor in a second direction opposite to the first direction during the output pulse.

13. An apparatus for implementing a neuron electrical circuit, comprising:
means for integrating current with a memristor in the neuron electrical circuit to cause a change in a membrane voltage potential; and
means for generating an output pulse when the membrane voltage potential reaches a threshold level, the output pulse indicating firing of the neuron electrical circuit.

14. The apparatus of claim 13, wherein the output pulse is of a defined duration.

15. The apparatus of claim 14, wherein the defined duration is chosen such that a resistance of the memristor changes to a defined value during the output pulse.

16. The apparatus of claim 14, wherein a resistance of the memristor increases only during the output pulse.

17. The apparatus of claim 14, wherein a resistance of the memristor decreases if the membrane voltage potential is larger than the threshold level.

18. The apparatus of claim 13, wherein:
a first constant electrical current flows through the memristor in a first direction, before the membrane voltage potential reaches the threshold level during the change; and
a second constant electrical current flows through the memristor in a second direction opposite to the first direction during the output pulse.

19. An electrical circuit, comprising:
a memristor configured to integrate an input electrical current, wherein a voltage potential across the memristor changes as the electrical current flows through the memristor; and
a firing circuit configured to generate an output pulse when the voltage potential reaches a threshold level, the output pulse indicating firing of the electrical circuit.

20. The electrical circuit of claim 19, wherein:
the output pulse is of a defined duration chosen such that a resistance of the memristor changes to a defined value during the output pulse.

21. The electrical circuit of claim 20, wherein the resistance of the memristor increases only during the output pulse.

22. The electrical circuit of claim 20, wherein the resistance of the memristor decreases if the voltage potential is larger than the threshold level.

23. The electrical circuit of claim 19, wherein:
a first constant electrical current flows through the memristor in a first direction, before the voltage potential reaches the threshold level during the change; and
a second constant electrical current flows through the memristor in a second direction opposite to the first direction during the output pulse.

24. A method for implementing an electrical circuit, comprising:
integrating an electrical current with a memristor in the electrical circuit, wherein a voltage potential across the memristor changes as the electrical current flows through the memristor; and
generating an output pulse when the voltage potential reaches a threshold level, the output pulse indicating firing of the electrical circuit.

25. The method of claim 24, wherein:
the output pulse is of a defined duration chosen such that a resistance of the memristor changes to a defined value during the output pulse.

26. The method of claim 25, wherein the resistance of the memristor increases only during the output pulse.

27. The method of claim 25, wherein the resistance of the memristor decreases if the voltage potential is larger than the threshold level.

28. The method of claim 24, wherein:
a first constant electrical current flows through the memristor in a first direction, before the voltage potential reaches the threshold level during the change; and
a second constant electrical current flows through the memristor in a second direction opposite to the first direction during the output pulse.

29. An apparatus for implementing an electrical circuit, comprising:
means for integrating an electrical current with a memristor in the electrical circuit, wherein a voltage potential across the memristor changes as the electrical current flows through the memristor; and
means for generating an output pulse when the voltage potential reaches a threshold level, the output pulse indicating firing of the electrical circuit.

30. The apparatus of claim 29, wherein:
the output pulse is of a defined duration chosen such that a resistance of the memristor changes to a defined value during the output pulse.

31. The apparatus of claim 30, wherein the resistance of the memristor increases only during the output pulse.

32. The apparatus of claim 30, wherein the resistance of the memristor decreases if the voltage potential is larger than the threshold level.

33. The apparatus of claim 29, wherein:
a first constant electrical current flows through the memristor in a first direction, before the voltage potential reaches the threshold level during the change; and
a second constant electrical current flows through the memristor in a second direction opposite to the first direction during the output pulse.
